(19) United States
(12) Patent Application Publication
(10) Pub. No.: US 2026/0131811 A1
(43) Pub. Date: May 14, 2026

(54) HAZARD ALERT SYSTEM FOR A VEHICLE

(71) Applicant: GM Global Technology Operations LLC, Detroit, MI (US)

(72) Inventors: Gaston Solodky, Kfar Saba (IL); Ilia Rozenberg, Ariel (IL); Itay Vitenstein, Ashdod (IL)

(73) Assignee: GM Global Technology Operations LLC, Detroit, MI (US)

(21) Appl. No.: 18/948,136

(22) Filed: Nov. 14, 2024

(51) Int. Cl. B60W 50/14; G01S 13/931; G06F 18/23

(52) U.S. Cl. CPC B60W 50/14; G01S 13/931; G06F 18/23; B60W 2420/408; B60W 2552/05; G01S 2013/9322

(57) ABSTRACT

A computer-implemented method when executed by data processing hardware causes the data processing hardware to perform operations. The operations include receiving, via a radar system of a vehicle, radar data, identifying, via a hazard alert algorithm, multipath clusters based on the radar data, and estimating, via the hazard alert algorithm, a local reflection coefficient for one or more of the multipath clusters. The operations also include comparing, via the hazard alert algorithm, the local reflection coefficient to a global reflection coefficient stored by a hazard alert system, identifying, based on the comparison of the local reflection coefficient with the global reflection coefficient, an abnormality, and updating a hazard list of the hazard alert algorithm with the identified abnormality. The operations further include estimating, based on the updated hazard list, a hazard type and issuing, via the hazard alert algorithm, an alert including the estimated hazard type.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a hazard alert system for a vehicle.

Vehicles may be equipped with various alert systems that may assist a driver to avoid potential collisions or other impacts with the vehicle. For example, many vehicles are equipped with a front assist system that may detect objects, such as other vehicles, in front of the vehicle. Front assist systems may utilize imaging systems such as cameras, Light Detection and Ranging (LiDAR), and radar. While front assist systems are useful for detecting a potential object or collision, the front assist systems may fail to anticipate potential hazards on the road and do not inform the driver of the type of road and hazards. Further, front assist systems do not utilize static infrastructure to sample and project multiple points along the roadway. Thus, there is a need for improved monitoring systems for vehicles to better detect potential hazards along the roadway.

### SUMMARY

In some aspects, a computer-implemented method when executed by data processing hardware causes the data processing hardware to perform operations. The operations include receiving, via a radar system of a vehicle, radar data, identifying, via a hazard alert algorithm, multipath clusters based on the radar data, and estimating, via the hazard alert algorithm, a local reflection coefficient for one or more of the multipath clusters. The operations also include comparing, via the hazard alert algorithm, the local reflection coefficient to a global reflection coefficient stored by a hazard alert system, identifying, based on the comparison of the local reflection coefficient with the global reflection coefficient, an abnormality, and updating a hazard list of the hazard alert algorithm with the identified abnormality. The operations further include estimating, based on the updated hazard list, a hazard type and issuing, via the hazard alert algorithm, an alert including the estimated hazard type.

The operations may optionally include estimating, via the hazard alert algorithm, a reflecting point location of the radar data on a road surface. The operations may also include identifying, based on the reflecting point location, an in-road boundary. In some examples, identifying the in-road boundary may include identifying a road type. Optionally, identifying the multipath clusters may include generating geometrical layout criteria and identifying the multipath clusters that meet the geometrical layout criteria. In some instances, identifying the multipath clusters may include generating an amplitude test and identifying the multipath clusters based on the amplitude test. The operations may also include generating, based on the comparison of the local reflection coefficient with the global reflection coefficient, weights for an estimated global reflection coefficient. The operations may further include updating the global reflection coefficient based on the generated weights and updating the road surface type of the global reflection coefficient.

In another aspect, a hazard alert system includes data processing hardware and memory hardware in communication with the data processing hardware. The memory hardware stores instructions that when executed on the data processing hardware cause the data processing hardware to perform operations. The operations include receiving, via a radar system of a vehicle, radar data, identifying, via a hazard alert algorithm, multipath clusters based on the radar data, and estimating, via the hazard alert algorithm, a local reflection coefficient for one or more of the multipath clusters. The operations also include comparing, via the hazard alert algorithm, the local reflection coefficient to a global reflection coefficient stored by a hazard alert system, identifying, based on the comparison of the local reflection coefficient with the global reflection coefficient, an abnormality, and updating a hazard list of the hazard alert algorithm with the identified abnormality. The operations further include estimating, based on the updated hazard list, a hazard type and issuing, via the hazard alert algorithm, an alert including the estimated hazard type.

The operations may optionally include estimating, via the hazard alert algorithm, a reflecting point location of the radar data on a road surface. The operations may also include identifying, based on the reflecting point location, an in-road boundary. In some examples identifying the in-road boundary may include identifying a road type. Optionally, identifying the multipath clusters may include generating geometrical layout criteria and identifying the multipath clusters that meet the geometrical layout criteria. In some instances, the multipath clusters may include a target and one or more ghost targets. In other examples, identifying the multipath clusters may include sampling, via a static infrastructure, a plurality of road points. The operations may also include generating, based on the comparison of the local reflection coefficient with the global reflection coefficient, weights for an estimated global reflection coefficient. The operations may further include updating the global reflection coefficient based on the generated weights.

In other aspects, a hazard alert system for a vehicle includes data processing hardware and memory hardware in communication with the data processing hardware. The memory hardware stores instructions that when executed on the data processing hardware cause the data processing hardware to perform operations. The operations include receiving, via a radar system of the vehicle, one or more inputs, identifying, via a hazard alert algorithm, multipath clusters based on the one or more inputs, and estimating, via the hazard alert algorithm, a reflecting point location on a road surface. The operations also include identifying, based on the reflecting point location, an in-road boundary, estimating, via the hazard alert algorithm, a local reflection coefficient for one or more of the multipath clusters, and comparing, via the hazard alert algorithm, the local reflection coefficient to a global reflection coefficient stored by a hazard alert system. The operations further include identifying, based on the comparison of the local reflection coefficient with the global reflection coefficient, an abnormality, updating a hazard list of the hazard alert algorithm with the identified abnormality, estimating, based on the updated hazard list, a hazard type, and issuing, via the hazard alert algorithm, an alert including the estimated hazard type.

In some examples, the operations may optionally include generating, based on the comparison of the local reflection coefficient with the global reflection coefficient, weights for an estimated global reflection coefficient and updating the global reflection coefficient based on the generated weights.

### BRIEF DESCRIPTION OF THE DRAWINGS

The drawings described herein are for illustrative purposes only of selected configurations and are not intended to limit the scope of the present disclosure.

FIG. 1 is a schematic diagram of a vehicle equipped with a hazard alert system according to the present disclosure;

FIG. 2 is an exemplary block diagram of a hazard alert system according to the present disclosure;

FIG. 3 is a schematic of a vehicle equipped with a hazard alert system according to the present disclosure, the vehicle equipped with a radar system configured to identify a hazard and traveling along a roadway;

FIG. 4 is another exemplary block diagram of a hazard alert system according to the present disclosure;

FIG. 5 is a schematic diagram of a radar system and multipath effect of a hazard alert system according to the present disclosure;

FIG. 6 is an exemplary flow diagram for a hazard alert system according to the present disclosure; and

FIG. 7 is an exemplary method of implementing a hazard alert system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

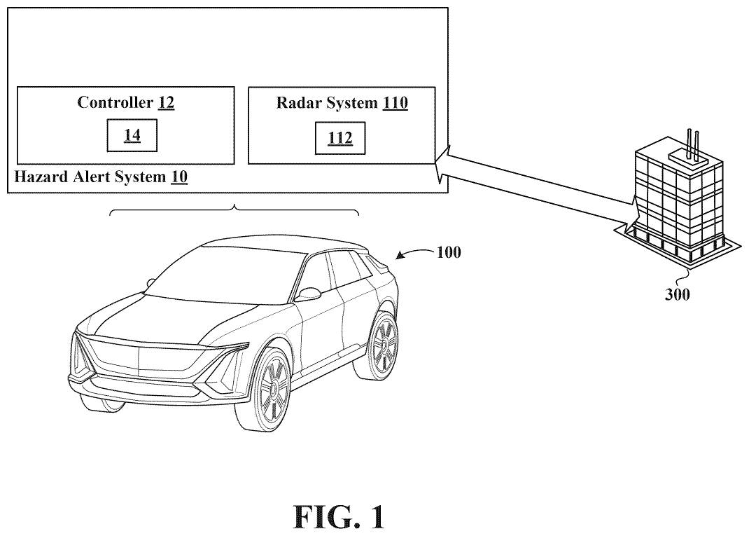

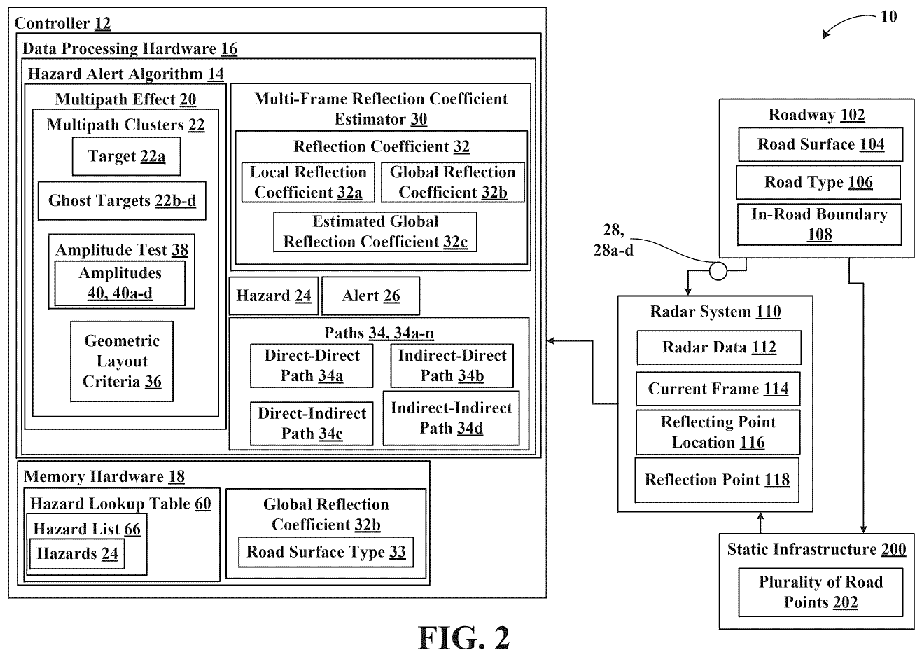

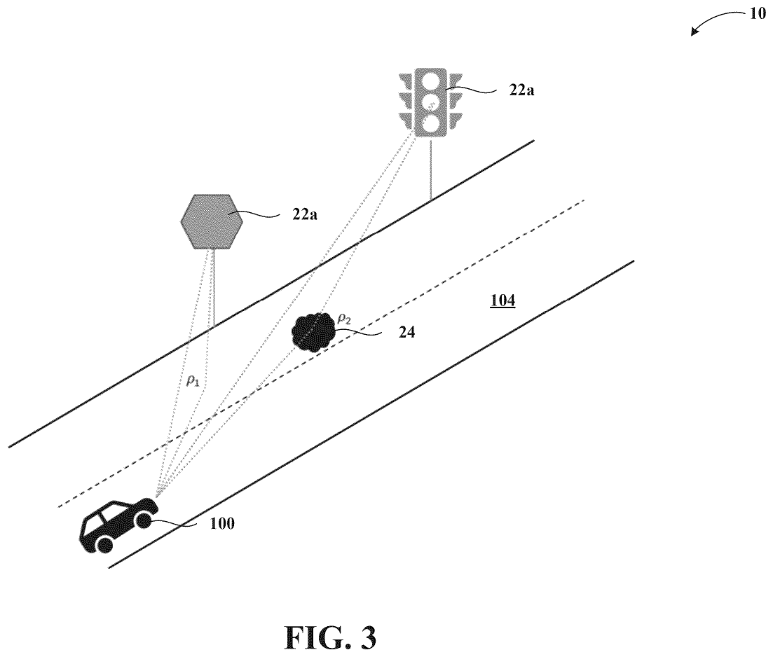

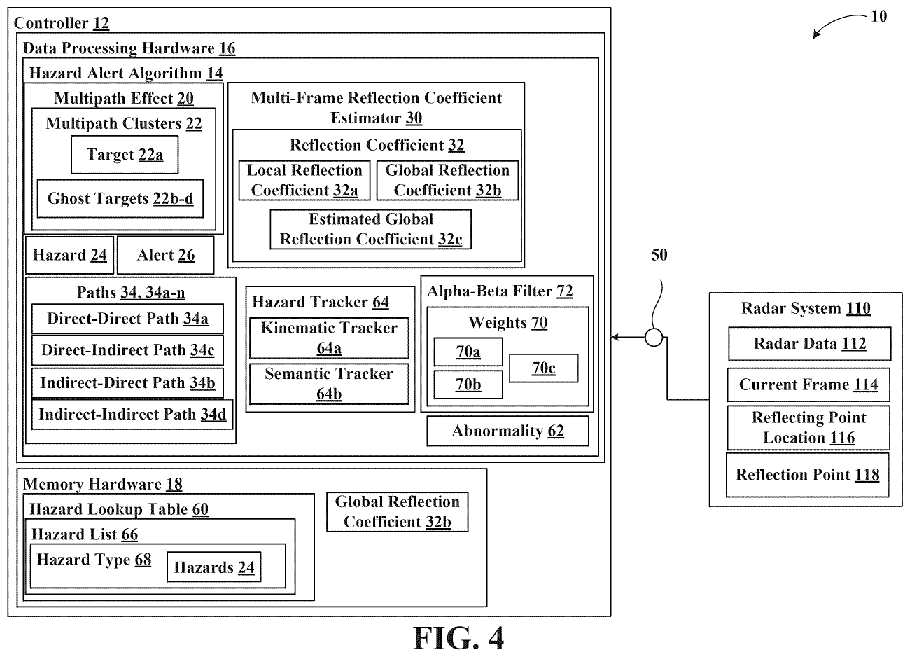

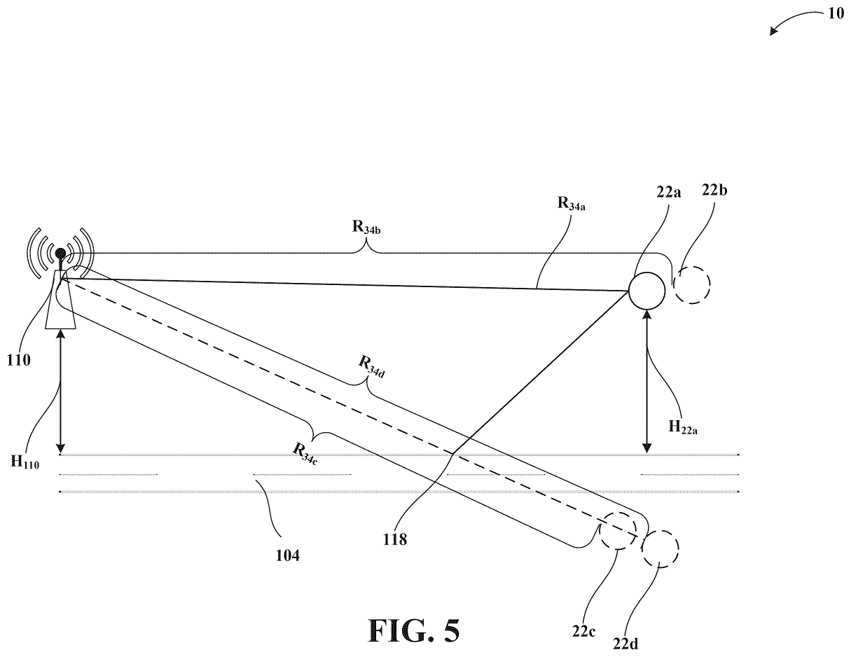

Referring to FIGS. 1-5, a hazard alert system 10 includes a controller 12 configured with a hazard alert algorithm 14. The controller 12 may be configured as part of a vehicle 100 equipped with the hazard alert system 10. The vehicle 100 may also be equipped with a radar system 110 configured to gather radar data 112. For example, the radar data 112 may include a current frame 114. The radar system 110 is communicatively coupled with a static infrastructure 200 to receive a plurality of road points 202 that generally correspond to the current frame 114 captured by the radar system 110. For example, the radar system 110 is configured to sample the plurality of road points 202 from the static infrastructure 200 to, at least in part, gather the radar data 112.

The radar system 110 gathers the radar data 112 received from the static infrastructure 200 and road points 202 from a roadway 102. The radar system 110 may capture the radar data 112 from reflections off a road surface 104 of the roadway 102, described in more detail below. The reflected static infrastructure 200 may store data with respect to the roadway 102. For example, the reflected static infrastructure 200 may store a road type 106 of the roadway 102, which may be communicated with and utilized by the radar system 110. The radar system 110 may communicate the road type 106 with the hazard alert algorithm 14, described in more detail below. The hazard alert algorithm 14 receives the radar data 112 from the radar system 110 and may estimate a reflecting point location 116 of the radar data on the road surface 104. Further, the hazard alert system 10 may identify, based on the reflecting point location 116, an in-road boundary 108 of the roadway 102 and reflection coefficient 32.

The hazard alert algorithm 14 is executed by data processing hardware 16 of the controller 12. The controller 12 also includes memory hardware in communication with the data processing hardware 16. The memory hardware stores instructions that when executed on the data processing hardware 16 cause the data processing hardware 16 to perform operations described herein. The hazard alert algorithm 14 is configured to detect a multipath effect 20 based on the radar data 112. The multipath effect 20 may be utilized by the hazard alert algorithm 14 to identify multipath clusters 22 based on the radar data 112. As described in more detail below, the multipath clusters 22 may be utilized to identify a hazard 24 and the road type 106 of the roadway 102, and the hazard alert algorithm 14 may issue an alert 26 to a driver of the vehicle 100. For example, the hazard 24 may include, but is not limited to, an oil spot, a pothole, and/or any other obstruction or object along the roadway 102 that may affect a trajectory of the vehicle 100. The alert 26 may alert the driver as to the hazard 24 identified from the multipath clusters 22.

The multipath clusters 22 include a target 22a and one or more ghost targets 22b-d. The multipath clusters 22 are identified by the radar system 110, in part, from sampling the plurality of road points 202 from the static infrastructure 200. The radar system 110 receives signals 28, 28a-n from the target 22a and ghost targets 22b-d, such that the radar data 112 communicated with the hazard alert algorithm 14 reports multiple targets 22a-d based on the signals 28, 28a-n. The hazard alert algorithm 14 is configured with a multi-frame reflection coefficient estimator 30 that is configured to detect and extract information about the road surface 104 from the ghost targets 22b-d when a reference signal 28a is coming from the target 22a.

The multi-frame reflection coefficient estimator 30 is a real-time estimator of reflection coefficients 32, 32a-n that utilizes information carried by a plurality of paths 34, 34a-n of the multipath clusters 22. For example, the plurality of paths 34, 34a-n include a direct-direct path 34a, an indirect-direct path 34b, a direct-indirect path 34c, and an indirect-indirect path 34d. The direct-direct path 34a is going towards the target and back to the radar system 110. Each of the indirect-direct path 34b, the direct-indirect path 34c, and the indirect-indirect path 34d represent the ghost targets 22b-d. The multi-frame reflection coefficient estimator 30 utilizes the information carried by the direct path 34a and the indirect paths 34b-d to estimate the respective reflection coefficients 32. When the signals 28, 28a-n are transmitted towards the target 22a, the direct path 34a is defined, and the multi-frame reflection coefficient estimator 30 utilizes the direct path 34a as a reference to extract information from the indirect paths 34b-d that contain information about the reflection coefficients 32, 32a-n.

The hazard alert algorithm 14 utilizes geometrical layout criteria 36 to identify the multipath clusters 22. For example, the hazard alert algorithm 14 generates the geometrical layout criteria 36 and identifies the multipath clusters that meet the geometrical layout criteria 36. The geometrical layout criteria 36 includes an elevation E₃₄ₐ of the direct-direct path 34a, an elevation E₃₄ₐ of the indirect-indirect path 34d, a height H₂₂ₐ of the target 22a, a height H₁₁₀ of the radar system 110, a range R_{34d} of the indirect-indirect path 34d, and a range R₃₄ₐ of the direct-direct path 34a. The multipath clusters 22 are compared with the geometrical layout criteria 36 to identify the clusters 22 that meet the criteria 36, described in more detail below. The geometrical layout criteria 36 is utilized to orient the radar system 110 and the target 22a relative to the road surface 104. The hazard alert algorithm 14 assesses the multipath clusters 22 and the paths 34, 34a-d to determine if the target path 34a (i.e., the direct-direct path 34a) and the indirect-indirect path 34d meet the geometric layout criteria 36.

Once the hazard alert algorithm 14 identifies the target path 34a and the indirect-indirect path 34d based on the geometric layout criteria 36, the hazard alert algorithm 14 works to identify the indirect-direct path 34b and the direct-indirect path 34c. The ghost targets 22b, 22c may be referred to as intermediary ghost targets 22b, 22c and the corresponding paths 34b, 34c may be referred to as intermediary paths 34b, 34c. The target path 34a is the shortest path between the radar system 110 and the target 22a, and the indirect-indirect path 34d is the longest path between the radar system 110 and the target 22a, via the ghost target 22d. The hazard alert algorithm 14 searches between the target path 34a and the indirect-indirect path 34d to identify whether the intermediary paths 34b, 34c each have a range R_{34b}, R_{34c} that falls within a center of the range between the target 22a and the ghost target 22d. The first intermediary ghost target 22b will have the same elevation E₂₂ₐ of the target 22a, and the second intermediary ghost target 22c will have the same elevation E₂₂ₐ as the ghost target 22d.

The hazard alert algorithm 14 utilizes resolution of the range to separate between the target 22a and the ghost target 22d. The intermediary ghost targets 22b, 22c are the average between the ranges R₂₂ₐ, R₂₂ₐ of the target 22a and the ghost target 22d. If there is low resolution, then the hazard alert algorithm 14 only utilizes the single detection of the target 22a and the ghost target 22d. In this instance, the hazard alert algorithm 14 will identify a single intermediary ghost target 22b, 22c. In order to verify the ghost targets 22b, 22c, in the event of high enough elevation resolution, the hazard alert algorithm 14 executes an amplitude test 38 to identify amplitudes 40, 40a-d of the multipath clusters 22. The amplitude test 38 is utilized to verify the relationship between the ghost targets 22b-d with the target 22a relative to the road surface 104. The amplitudes ratio 40, 40a-d range between zero (0) and one (1). The relationship between the intermediary ghost targets 22b, 22c is one (1). If the relationship of the amplitudes 40, 40a-d match, then the hazard alert algorithm 14 will determine that all of the ghost targets 22b-d came from the same source (i.e., the target 22a).

With further reference to FIGS. 1-5, the multi-frame reflection coefficient estimator 30 is utilized to distinguish between a local reflection coefficient 32a and a global reflection coefficient 32b. The multi-frame reflection coefficient estimator 30 also improves the estimation accuracy of both the global reflection coefficient 32b and the local reflection coefficient 32a. The reflection coefficients 32, 32a-n are calculated from the signals 28, 28a-n associated with the target 22a and ghost targets 22b-d. The multi-frame reflection coefficient estimator 30 utilizes the multipath clusters 22 to identify which signal 28a is from the target 22a and which signals 28b-d are from the ghost targets 22b-d. For example, the multi-frame reflection coefficient estimator 30 may utilize reflection points 118 captured from previous frames as part of the radar data 112 to estimate the reflecting point location 116 of the radar data 112 on the road surface 104, mentioned above. The hazard alert algorithm 14 receives a signal 28a corresponding to the target 22a in the presence of the road surface 104 (i.e., a reflection surface) and also receives the signals 28b-d corresponding to the ghost targets 22b-d. The multi-frame reflection coefficient estimator 30 is able to identify that the signals 28 come from the same target 22a, such that the target 22a is the source of the ghost targets 22b-d. The hazard alert algorithm 14 is configured to extract information about the road surface 104 from the ghost targets 22b-d by assessing the signal 28a from the target 22a.

The current frame 114 from the radar data 112 represents a time frame and is received by the hazard alert algorithm 14 as an input 50. The inputs 50 may also correspond to the signals 28 and previously tracked hazards 24 that may be stored as part of a hazard lookup table 60 in the memory hardware 18. The inputs 50 are received by the hazard alert algorithm 14 and utilized with the multi-frame reflection coefficient estimator 30 to estimate the reflection point 118 on the road surface 104 for each multipath cluster 22. Based on the reflection point 118, the multi-frame reflection coefficient estimator 30 to estimate the local reflection coefficient 32a for one or more of the multipath clusters 22. To evaluate the reflection coefficient 32, the multi-frame reflection coefficient estimator 30 uses a multi-frame approach to estimate the local reflection coefficient 32a. The multi-frame approach improves the accuracy of the estimation of the local and global reflection coefficients 32a, 32b.

The local reflection coefficient 32a is compared to the global reflection coefficient 32b. The global reflection coefficient 32b may be stored in the memory hardware 18 and utilized by the hazard alert algorithm 14 for comparison with the estimated local reflection coefficient 32a. The global reflection coefficient 32b contains information on the road surface type 33. The hazard alert algorithm 14 may be configured to detect a change in the global reflection coefficient 32b corresponding to a change in the road surface type 33 to issue the alert 26. For example, the road surface type 33 may change from a concrete road type to a dust or gravel road type, which may prompt the hazard alert algorithm 14 to issue an alert 26 notifying a driver or controller of the change.

In some instances, the comparison of the local reflection coefficient 32a with the global reflection coefficient 32b may result in an abnormality 62. The abnormality 62 results in the local reflection coefficient 32a being labeled a hazard 24 and being input into a hazard tracker 64 of the hazard alert algorithm 14. The hazard tracker 64 includes a kinematic tracker 64a and a semantic tracker 64b. The hazard tracker 64 associates the abnormality 62 to a hazard list 66 of the hazard lookup table 60 to identify a hazard type 68. If the abnormality 62 matches one of the hazards 24 on the hazard list 66, then the hazard alert algorithm 14 will update the hazard 24 on the hazard list 66 and identify the hazard type 68. For example, the hazard tracker 64 may check the hazard lookup table 60 according to reflection coefficient 32 to identify the hazard type 68. Once the hazard type 68 is identified, the hazard alert algorithm 14 issues the alert 26 identifying the hazard 24 for the driver of the vehicle 100. If the abnormality 62 does not match a hazard 24 on the hazard list 66, then the hazard alert algorithm 14 will initiate a new hazard 24.

The hazard alert algorithm 14 utilizes the hazard tracker 64 to identify the previously tracked hazard 24 to associate with the newly identified hazard 24. The hazard alert algorithm 14 tries to associate the current hazard 24 with the previously tracked hazard 24 by using the hazard tracker 64. For example, the kinematic tracker 64a is utilized to associate the current hazard 24 with a location of the previously tracked hazard 24. The semantic tracker 64b is utilized to associate the current hazard with the reflection coefficient of the previously tracked hazard 24.

In some instances, the comparison of the local reflection coefficient 32a with the global reflection coefficient 32b does not result in an abnormality 62. The hazard alert algorithm 14 may utilize the lack of an abnormality 62 to improve the accuracy of an estimation of the global reflection coefficient 32b of the roadway 102. For example, the hazard alert algorithm 14 may use the global reflection coefficient 32b to classify the road type 106 and report the road type 106 to the driver of the vehicle 100. In some instances, the controller 12 may be in communication with a back-office server 300 (FIG. 1) to which the hazard alert algorithm 14 may communicate the alert 26 and/or the road type 106 identified by the comparison of the local reflection coefficient 32a with the global reflection coefficient 32b. In some examples and configurations, the hazard alert algorithm 14 may be executed and implemented by the back-office server 300 and the alert 26 and the road type 106 is communicated with the controller 12 of the vehicle 100 for communication with the driver of the vehicle 100.

The hazard alert algorithm 14 generates, based on the comparison of the local reflection coefficient 32a with the global reflection coefficient 32b, weights 70 for an estimated global reflection coefficient 32c. The hazard alert algorithm 14 utilizes an alpha-beta filter 72 to generate the weights 70. The weights 70 are generated based on the comparison of the local reflection coefficient 32a with the global reflection coefficient 32b and are utilized for an updated, estimated global reflection coefficient 32c. For example, the weights 70 may be calculated using a function based on factors including the signal-to-noise (SNR) ratio, the number of peaks used in estimation, and the difference in local reflection coefficients 32a. The weights 70 may be calculated using the following exemplary equation:

$$( a ) {w}_{i} = {W}_{SNR} {W}_{NPeaks} {W}_{ρ diff}$$

Where W_{SNR} is SNR weights 70a, W_{NPeaks} is the number of peaks 70b, and W_{pdiff} is the local reflection coefficient distance weights 70c. The SNR weights 70a assign greater weights to points with a high SNR. The higher the SNR, the greater the accuracy of the point. The higher number of peaks 70b in a cluster 22 results in a high local reflection coefficient estimation 32a, resulting in a great weight in the total estimation. The local reflection coefficient difference weights 70c may have a high difference, which indicates the presence of a hazard rather than road surface information. The high difference results in a lower associated weight 70. In comparison, when all local reflection coefficient 32a values exhibit significant differences, it suggests a change in the road surface 104.

The weights 70 generated by the alpha-beta filter 72 improve the accuracy of the estimation of the reflection coefficients 32 by the hazard alert algorithm 14. The weights 70 may range between zero (0) and one (1), such that a weight 70 of zero (0) indicates that the hazard alert algorithm 14 should rely on the past reflection coefficient 32 over the current. A weight 70 of one (1) indicates that the current reflection coefficient 32 is accurate, and the hazard alert algorithm 14 can neglect the past reflection coefficient 32. The estimation is improved by the hazard alert algorithm 14 utilizing the previous reflection coefficient 32 of the hazard 24 and the new, measured reflection coefficient 32 of the hazard 24 to calculate a new, updated global reflection coefficient 32b.

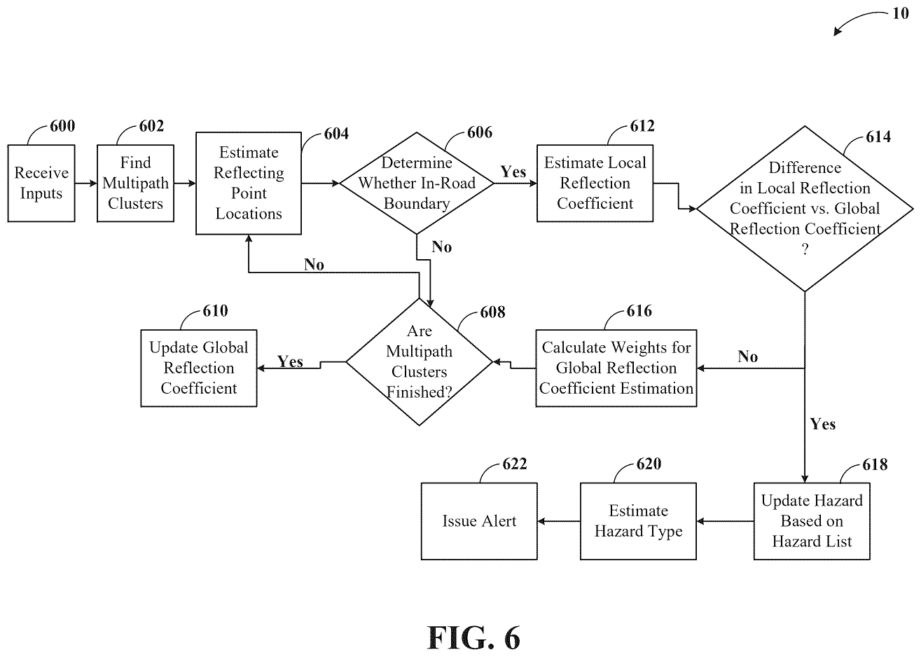

Referring now to FIG. 6, an exemplary flow diagram of the hazard alert system 10 is illustrated. At 600, the hazard alert system 10 receives the inputs 50 and finds, at 602, the multipath clusters 22. The hazard alert algorithm 14 estimates, at 604, the reflecting point locations 116. The hazard alert algorithm 14, at 606, determines whether there are any in-road boundaries 108. If no, then the hazard alert algorithm 14 determines, at 608, whether the multipath clusters 22 are finished. If the multipath clusters 22 are not finished, then the hazard alert algorithm 14 returns to estimating, at 604, the reflecting point locations. If the multipath clusters 22 are finished, then the hazard alert algorithm 14 updates, at 610, the global reflection coefficient 32b. If there are multipath clustered reflection points in-road boundaries 108, then the hazard alert algorithm 14 estimates, at 612, a local reflection coefficient 32a, for each cluster. The hazard alert algorithm 14 then determines, at 614, whether there is a difference between the local reflection coefficient 32a and the global reflection coefficient 32b. If there is no difference, then the hazard alert algorithm 14 calculates, 616, the weights 70 for the global reflection coefficient 32b estimation and proceeds with steps 608 and 610. If there is a difference between the local reflection coefficient 32a and the global reflection coefficient 32b, then the hazard alert algorithm 14 updates, at 618, the hazard 24 based on the hazard list 66. The hazard alert algorithm 14 estimates, at 620, the hazard type 68 and issues, at 622, an alert 26.

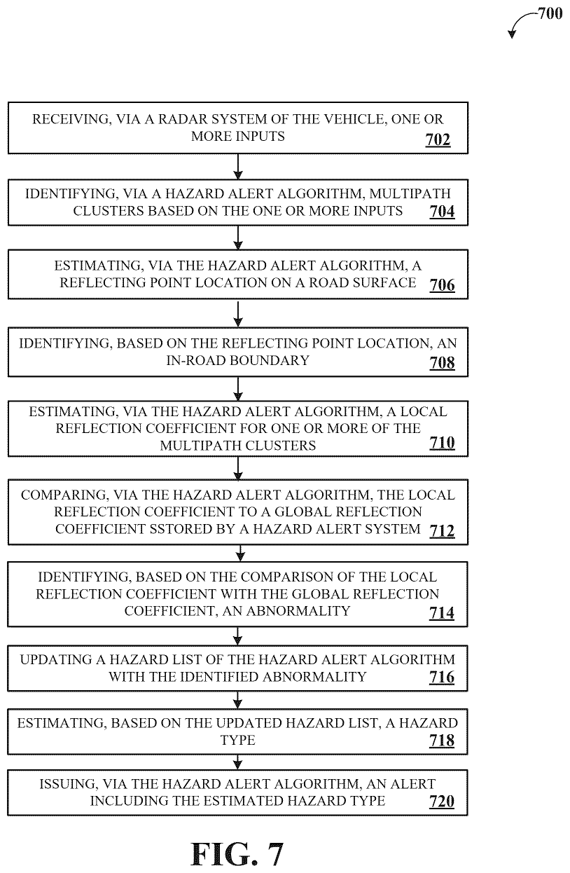

Referring now to FIG. 7, an exemplary method 700 for the hazard alert system 10 is illustrated. At 702, the hazard alert system 10 receives, via a radar system 110 of a vehicle 100, radar data 112 and identifies, at 704, via a hazard alert algorithm 14, multipath clusters 22 based on the radar data 112. The hazard alert algorithm 14 estimates, at 706, a reflecting point location 116 on a road surface 104 and identifies, at 708, based on the reflecting point location 116, an in-road boundary 108. The hazard alert algorithm 14 estimates, at 710, a local reflection coefficient 32b for one or more of the multipath clusters 22 and compares, at 712, the local reflection coefficient 32a to a global reflection coefficient 32b stored by the hazard alert system 10. The hazard alert algorithm 14 identifies, at 714, based on the comparison of the local reflection coefficient 32a with the global reflection coefficient 32b, an abnormality 62. At, 716, a hazard list 66 of the hazard alert algorithm 14 is updated with the identified abnormality 62. The hazard alert algorithm 14 estimates, at 718, based on the updated hazard list 66, a hazard type 68 and issues, at 720, an alert 26 including the estimated hazard type 68.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
receiving, via a radar system of a vehicle, radar data;
identifying, via a hazard alert algorithm, multipath clusters based on the radar data;
estimating, via the hazard alert algorithm, a local reflection coefficient for one or more of the multipath clusters;
comparing, via the hazard alert algorithm, the local reflection coefficient to a global reflection coefficient stored by a hazard alert system;
identifying, based on the comparison of the local reflection coefficient with the global reflection coefficient, an abnormality;
updating a hazard list of the hazard alert algorithm with the identified abnormality;
estimating, based on the updated hazard list, a hazard type; and
issuing, via the hazard alert algorithm, an alert including the estimated hazard type.

2. The method of claim 1, further including estimating, via the hazard alert algorithm, a reflecting point location of the radar data on a road surface.

3. The method of claim 2, further including identifying, based on the reflecting point location, an in-road boundary.

4. The method of claim 3, wherein identifying the in-road boundary includes identifying a road type.

5. The method of claim 1, wherein identifying the multipath clusters includes generating geometrical layout criteria and identifying the multipath clusters that meet the geometrical layout criteria.

6. The method of claim 1, wherein identifying the multipath clusters includes generating an amplitude test and identifying the multipath clusters based on the amplitude test.

7. The method of claim 1, wherein identifying the multipath clusters includes sampling, via a static infrastructure, a plurality of road points.

8. The method of claim 1, further including generating, based on the comparison of the local reflection coefficient with the global reflection coefficient, weights for an estimated global reflection coefficient.

9. The method of claim 8, further including updating the global reflection coefficient based on the generated weights and updating the road surface type of the global reflection coefficient.

10. A hazard alert system comprising:
data processing hardware; and
memory hardware in communication with the data processing hardware, the memory hardware storing instructions that when executed on the data processing hardware cause the data processing hardware to perform operations comprising:
receiving, via a radar system of a vehicle, radar data;
identifying, via a hazard alert algorithm, multipath clusters based on the radar data;
estimating, via the hazard alert algorithm, a local reflection coefficient for one or more of the multipath clusters;
comparing, via the hazard alert algorithm, the local reflection coefficient to a global reflection coefficient stored by a hazard alert system;
identifying, based on the comparison of the local reflection coefficient with the global reflection coefficient, an abnormality;
updating a hazard list of the hazard alert algorithm with the identified abnormality;
estimating, based on the updated hazard list, a hazard type; and
issuing, via the hazard alert algorithm, an alert including the estimated hazard type.

11. The hazard alert system of claim 10, further including estimating, via the hazard alert algorithm, a reflecting point location of the radar data on a road surface.

12. The hazard alert system of claim 11, further including identifying, based on the reflecting point location, an in-road boundary.

13. The hazard alert system of claim 12, wherein identifying the in-road boundary includes identifying a road type.

14. The hazard alert system of claim 10, wherein identifying the multipath clusters includes generating geometrical layout criteria and identifying the multipath clusters that meet the geometrical layout criteria.

15. The hazard alert system of claim 10, wherein the multipath clusters include a target and one or more ghost targets.

16. The hazard alert system of claim 10, wherein identifying the multipath clusters includes sampling, via a static infrastructure, a plurality of road points.

17. The hazard alert system of claim 10, further including generating, based on the comparison of the local reflection coefficient with the global reflection coefficient, weights for an estimated global reflection coefficient.

18. The hazard alert system of claim 17, further including updating the global reflection coefficient based on the generated weights.

19. A hazard alert system for a vehicle, the hazard alert system comprising:
data processing hardware; and
memory hardware in communication with the data processing hardware, the memory hardware storing instructions that when executed on the data processing hardware cause the data processing hardware to perform operations comprising:
receiving, via a radar system of the vehicle, one or more inputs;
identifying, via a hazard alert algorithm, multipath clusters based on the one or more inputs;
estimating, via the hazard alert algorithm, a reflecting point location on a road surface;
identifying, based on the reflecting point location, an in-road boundary;
estimating, via the hazard alert algorithm, a local reflection coefficient for one or more of the multipath clusters;
comparing, via the hazard alert algorithm, the local reflection coefficient to a global reflection coefficient stored by a hazard alert system;
identifying, based on the comparison of the local reflection coefficient with the global reflection coefficient, an abnormality;
updating a hazard list of the hazard alert algorithm with the identified abnormality;
estimating, based on the updated hazard list, a hazard type; and
issuing, via the hazard alert algorithm, an alert including the estimated hazard type.

20. The hazard alert system of claim 19, further including:
generating, based on the comparison of the local reflection coefficient with the global reflection coefficient, weights for an estimated global reflection coefficient; and
updating the global reflection coefficient based on the generated weights.
